(19) United States
(12) Patent Application Publication
(10) Pub. No.: US 2012/0269569 A1
(43) Pub. Date: Oct. 25, 2012

(54) Connecting spline for fluted plastic

(76) Inventors: Brooks Hamilton Roscoe, El Segundo, CA (US); Steven F. Wood, El Segundo, CA (US)

(21) Appl. No.: 13/066,650

(22) Filed: Apr. 21, 2011

(51) Int. Cl. F16B 5/00

(52) U.S. Cl. 403/119; 403/345

(57) ABSTRACT

An elongated spline made of injection molded plastic or some other material and having multiple sets of fingers that fit firmly into the row of pre-existing holes along the side edges of corrugated or fluted plastic so as to form strong, structural corners between two or more sheets of corrugated or fluted plastic.

### BACKGROUND OF INVENTION

Corrugated (or fluted) plastic has been around for decades serving as a more durable alternative to corrugated card-board for uses in signage and storage boxes, most notably as employed by the U.S. Postal Service for letter sorting.

These boxes have in the past been typically formed by scoring and folding sheets of corrugated plastic into their usable form.

Only in the past few years have fluted plastic manufacturers begun to extrude corrugated sheets of sufficient thickness (12, 15, 20 & 24 mm) to allow end-users to begin considering fluted plastic to replace wooden or melamine boards. It is at these thicker widths that the skin of the plastic itself can begin to be considered as a structural element and wherein my invention can work dynamically.

### SUMMARY OF THE INVENTION

One object of the present invention is to allow for the creation of multi-sided boxes with a minimum of labor and materials to form the box corners. Blocks, screws, bolts and braces can be eliminated and the above-described spline can be tapped into place giving the proper angle for the design with a touch of glue for permanence. These boxes can have any number of industrial and consumer uses from storage uses to formation of inner structures of furniture, displays, automotive components etc.

Aside from closed boxes, structures that require one or more angles but do not close into a box can be formed with equal ease.

Also, the spline can be fashioned with a single set of fingers and part of a hinge assembly or without the hinge, simply for making neat and decorative end-caps placed onto ragged-cut fluted plastic sheets.

### BRIEF DESCRIPTION OF THE DRAWINGS

FIG. 1 shows a single piece spline of injection molded plastic. The fingers (1) are fared at the tips for ease of insertion. The spline has a rounded or squared center-spine (2) which will make for a fixed-angle structure with various shaped corners.

FIG. 2 shows a version of the spline with intruding fingers (1) into fluted plastic boards as described in claim #1, but with a hinge, in this case, a piston (2) and socket(3) to allow for moving, varying angles between any two boards that are joined. Thus two separate pieces will make up each corner in this variation.

FIG. 3 shows two piston-and socket splines. One has been inverted vertically to allow for connecting.

### DETAILED DESCRIPTION

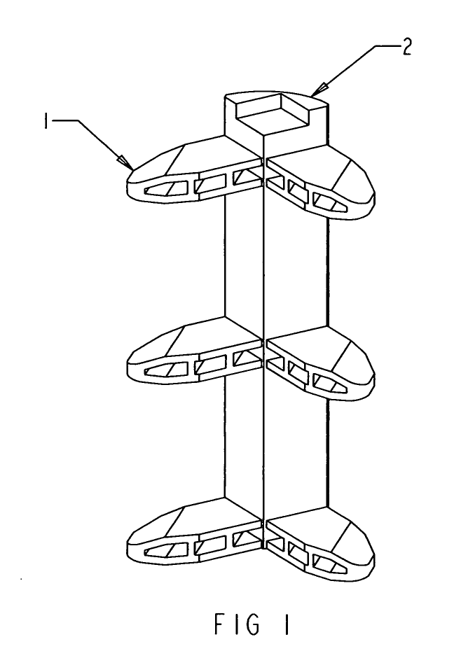

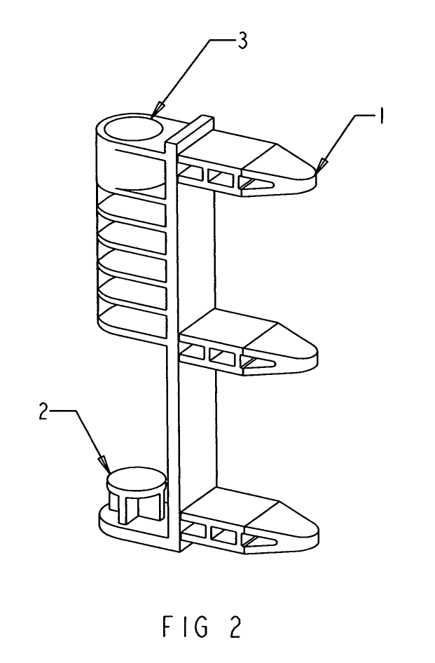

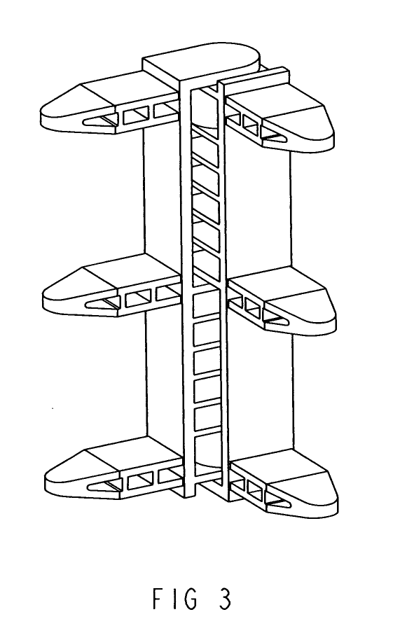

In the 2 embodiments of the invention illustrated, FIG. 1 shows a fixed angle spline and FIG. 2 and FIG. 3 show a spline allowing for varying angles.

FIG. 1 shows an injection-molded spline of plastic, typically of polypropylene or with strengthening additives, shaped in such a way as to have fingers that can be inserted snugly into corresponding slots of corrugated plastic. The fared points of each finger (1) allow for easy insertion into the voids of the corrugated plastic. The fingers join to the center stem (2) to give the piece strength and a fixed angle to create the corner.

In the case of the hinged spline shown in FIG. 2 and FIG. 3, two spline will form each corner with fingers of each spline (1) being inserted into a sheet of corrugated plastic exactly as described above for FIG. 1. But there is a piston (2) and a corresponding socket (3) on each spline. When these pistons and sockets interface with a second, inverted spline, they allow for the connection seen in FIG. 3. The results are a splined corner of fluted plastic boards that allow for a variable and moving angle.

I claim:

1. A connecting piece, or spline, fashioned from any variety of materials for combining sheets of fluted plastic with multiple fingers entering the holes (or flutes) along the edges of said sheets in order to make angles between two or more sheets for corner forming without need of extra joining materials such as nails, screw, and blocks and especially for making closed structures such as boxes with three sides or more when combining multiple sheets and multiple corner splines into the box or structure.

2. An elongated piece as claimed in section 1, wherein:
consisting of a single row of fingers that enter the holes or flutes of one sheet only as an end-cap to close up the flutes and to support a hinge for connecting to other sheets of fluted plastic.
